(19) United States
(12) Patent Application Publication
(10) Pub. No.: US 2003/0099402 A1
(43) Pub. Date: May 29, 2003

(54) Method for conducting and categorizing data

(76) Inventor: Charles M. Baylis, Cincinnati, OH (US)

Correspondence Address: Joseph A, Sebolt, SAND & SEBOLT, Aegis Tower, Suite 1100, 4940 Munson Street NW, Canton, OH, 44718-3615, US

(21) Appl. No.: 10/096,214

(22) Filed: Mar. 11, 2002

Related U.S. Application Data
(60) Provisional application No. 60/302,633, filed on Jul. 2, 2001.

(51) Int. Cl. G06K 9/72

(52) U.S. Cl. 382/229

(57) ABSTRACT

A method of analyzing a verbatim text comprising the steps of storing the verbatim text in an electronic memory device and identifying at least one concept in said verbatim text and linking said concept to a code.

### BACKGROUND OF THE INVENTION

1. Technical Field

The present invention relates to data processing and more particularly to data processing in the fields of linguistics and business methods. Still more particularly, the present invention relates to business methods useful in categorizing and coding responses to surveys.

2. Background Information

In the practice of conducting consumer and other surveys, open end coding is the process by which verbatim responses are assigned to categories. These categories represent the concept that the verbatim responses are expressing. It is a common task in the survey research industry to ask for verbatim responses from people who are interviewed. In many cases, small number of open ended questions are distributed within the larger number of closed ended questions. Such open ended questions might be there to clarify some of the closed end questions or to reveal information that is difficult to anticipate in a closed end category or to confirm closed end responses or as a way to generate ideas or concepts.

Referring to FIG. 1, a typical prior art method for categorizing and coding verbatim responses to a survey is shown. In a first step at block 10, key concepts in the verbatim response are located. An example of such a verbatim responses are shown in Table 1 with reference to block 10. In the next step shown in block 12, the analyst manually searches the verbatim response for matching concepts in a code book. Examples of such matching responses are shown adjacent block 12 in Table 1 with reference to block 10. In the next step shown in block 14, the analyst then records codes for such matching concepts. For example, and referring to Table 1 the codes “attractive model”, “has similar problems/experience”, “good pricing”, and “works in winter” are selected from the available codes in the code book from the interviewee's response.

TABLE 1

BLOCK 10
I liked the appearance of the model in the ad. I have similar
problems with static in my own hair. I can believe that this product
would work well, especially in the winter. And the price is right!
BLOCK 12
Ad Appeal
Good colors
Catchy slogan
Attractive Model
Believability
Faith in company
Agrees with product concept
Has similar problem/experience
Good pricing
Works in dry conditions
Works in winter
BLOCK 14
Attractive model
Has similar problems/experience
Good pricing
Works in winter

A difficulty with the prior art method of categorizing and coding verbatim responses is that it is expensive and time consuming since each response has to be individually studied by an analyst. The prior art method of categorizing and coding verbatim responses also may be somewhat subjective since each analyst studying the response may perceive somewhat different concepts in the verbatim responses. Furthermore, the possibility of erroneous conclusions based on differences in the languages in which the verbatim responses are obtained also exist.

### BRIEF SUMMARY OF THE INVENTION

It is an object of the present invention to provide a quick, easy, and cost effective method of categorizing and coding verbatim responses.

It is another object of the present invention to provide a highly objective method of categorizing and coding verbatim responses.

It is still another object of the present invention to provide a method of categorizing and coding verbatim responses which may be adapted for use in a plurality of languages.

These and other objects are met by the present invention which is a method of analyzing a verbatim text comprising the steps of storing the verbatim text in an electronic memory device, identifying at least one concept in said verbatim text and linking said concept to a code.

### BRIEF DESCRIPTION OF THE SEVERAL VIEWS OF THE DRAWINGS

The present invention is further described with reference to the accompanying drawings in which;

FIG. 1 is a schematic flow diagram illustrating a prior art method for categorizing and coding verbatim responses to surveys;

FIG. 2 is a schematic flow diagram illustrating a preferred embodiment of the present invention for categorizing and coding verbatim responses to surveys; and

FIGS. 3-46 are views of the computer monitor screens used in the practice of an example of the method of the invention.

### DETAILED DESCRIPTION OF THE INVENTION

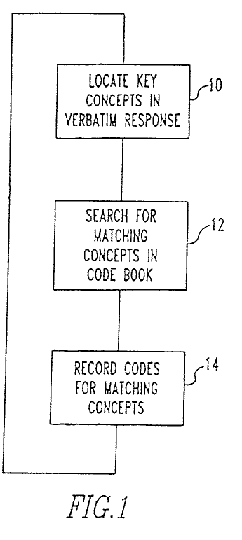

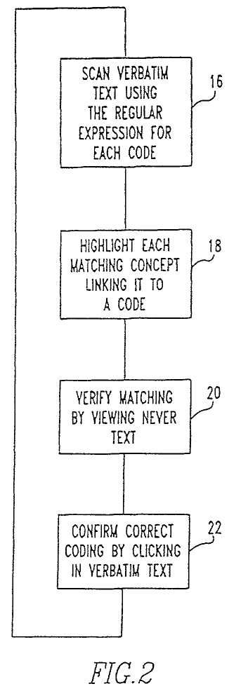

Referring to FIG. 2, the fist step in the method of the present invention is shown in block 16 in which the verbatim text is scanned using the regular expression for each code. The user may also directly enter the verbatim response into the memory of a computer at the time of the interview. Alternatively, another person may enter the verbatim response after the time of the interview. Again, the same example verbatim response as is shown in FIG. 1 is shown with reference to block 16 in Table 2. In the next step of this method is shown in block 18. Each concept is highlighted, thus linking such concept to a code. The highlighted concepts are shown with reference to block 18 in Table 2. In the next step of the method as is shown in block 20, matching is verified by using a hover text. Verification is shown adjacent block 20 in FIG. 2. Then there is a confirmation of correct coding by clicking in the verbatim text as is shown in block 22. The confirmed codes, “attractive model”, “has similar problems/experience”, “good pricing”, and “works in winter”.

TABLE 2

BLOCK 16
I liked the appearance of the model in the ad. I have similar
problems with static in my own hair. I can believe that this product
would work well, especially in the winter. And the price is right!
BLOCK 18
I liked the appearance of the model in the ad. I have similar
problems with static in my own hair. I can believe that this product
would work well, especially in the winter. And the price is right!
BLOCK 20
I liked the appearance of the model in the ad. I have similar
problems with static in my own hair. I can believe that this product
would work well, especially in the winter. And the price is right!
BLOCK 22
Attractive model
Has similar problems/experience
Good pricing
Works in winter

Those skilled in the art will appreciate that individual users may practice the method of the present invention on a computer network. Users may also make use of the internet which is a global collection of computer networks that provide individual users the ability to access internet services including the worldwide web (web). When making use of the internet, users will remotely login to high power computers known as servers connected to the internet.

Those skilled in the art will appreciate that the method of the present invention may be adapted for use in a plurality of languages.

In a preferred embodiment the logic flow to process a sample page in a web site which is used with this method. The page consists of standard HTML tags interspersed with identifiers for strings that need to be translated. An example of such an identifier is <%=XL.S(104)%>. This means “replace this with text string number 104 rendered in the language in use by the client.” An example of a page using making use of this method is shown in Table 3 below for translation.

TABLE 3

<HTML>
<BODY>
<OBJECT id=LLISupport PROGID=“LLSupport.Translator”
RUNAT=“Server”></OBJECT>
<H1><%=XL.S(104)%></H1>
<H2><%=XL.SS(103, FirstName)%></H2>
</BODY>
</HTML>

When a client navigates to a page in the web site, the logic flow is as listed in Table 4 below. The columns represent the four major actors in the scenario. These actors are:

Client

The client web browser, such as Microsoft Internet Explorer. The client is connected to the Web Server via the Internet.

Web Server

The software component that services requests from the Client. The innovation is applicable to any web server. We have implemented it on Microsoft Internet Information Server (IIS).

XL Object

An in-memory software object that maintains a set of translation strings. The innovation does not require this component. This component was added to improve the performance of the implementation by caching the translated strings from the database.

Database server

A repository of translated strings. In our implementation the database server is Microsoft SQL Server, but the innovation is applicable to any database server.

TABLE 4

| | | | Database |
|---|---|---|---|
| Client | Web Server | XL Object | server |
| Client browser | | | |
| sends an http | | | |
| request to view a | | | |
| page. The header | | | |
| of this request | | | |
| contains an HTTP | | | |
| ACCEPT | | | |
| LANGUAGE | | | |
| field that lists | | | |
| the languages | | | |
| acceptable to the | | | |
| client in order of | | | |
| preference. | | | |
| | The web server locates | | |
| | the requested page, and | | |
| | begins to prepare it for | | |
| | return to the client. | | |
| | The web server checks | | |
| | for an established | | |
| | session for this client. | | |
| | Because this is the first | | |
| | request from this client, | | |
| | there is no session. | | |
| | The web server asks for | | |
| | the client's credentials | | |
| | (username and | | |
| | password). | | |
| | The web server creates | | |
| | a session for this client. | | |
| | It passes the credentials | | |
| | for client to the XL | | |
| | Object, along with the | | |
| | list of acceptable | | |
| | languages. | | |
| | | The XL | |
| | | object | |
| | | submits a | |
| | | database | |
| | | query for a | |
| | | list of | |
| | | translations | |
| | | specific | |
| | | to this | |
| | | client, and | |
| | | for the first | |
| | | acceptable | |
| | | language. | |
| | | If this fails | |
| | | the | |
| | | process | |
| | | continues | |
| | | with the | |
| | | next | |
| | | acceptable | |
| | | language. | |
| | | As a final | |
| | | resort a | |
| | | query is | |
| | | made for | |
| | | English | |
| | | strings. | |
| | | | The |
| | | | database |
| | | | server |
| | | | returns the |
| | | | strings for |
| | | | this |
| | | | combination |
| | | | of client |
| | | | and |
| | | | language. |
| | | | Each string |
| | | | is identified |
| | | | by a |
| | | | numeric |
| | | | code. |
| | | The XL | |
| | | Object | |
| | | stores the | |
| | | strings in a | |
| | | collection | |
| | | indexed by | |
| | | the | |
| | | numeric | |
| | | code that | |
| | | identifies | |
| | | the string. | |
| | For each string in the | | |
| | page marked by the | | |
| | <%=XL.S(104)%> | | |
| | syntax, the web server | | |
| | requests the translated | | |
| | string from the XL | | |
| | Object. | | |
| | | The XL | |
| | | object | |
| | | locates the | |
| | | string in its | |
| | | collection | |
| | | of cached | |
| | | strings, | |
| | | using the | |
| | | numeric | |
| | | key. It | |
| | | returns this | |
| | | string to | |
| | | the web | |
| | | server. | |
| | When all strings have | | |
| | been translated, the web | | |
| | server sends the | | |
| | response to the client. | | |
| | In this response all | | |
| | strings marked by the | | |
| | <%=XL.S(104)%> | | |
| | syntax have been | | |
| | resolved to their | | |
| | translated values. | | |
| The client | | | |
| browser renders | | | |
| the page in | | | |
| the preferred | | | |
| language of the | | | |
| user. | | | |

Returning to the preferred embodiment above, the original page had the form shown on Table 4.

After the string substitution process the page has the form shown on the following Table 5.

TABLE 5

<HTML>
<BODY>
<OBJECT id=LLISupport PROGID=“LLSupport.Translator”
RUNAT=“Server”></OBJECT>
<H1>Welcome to Language Logic</H1>
<H2>Hello Charles!</H2>
</BODY>
</HTML>

This would be rendered by the browser for display as:

Welcome to Language Logic

Hello Charles!

If the preferred language were French, and if the client had populated the database with translations to French, the page might appear as is shown on the following Table 6.

TABLE 6

<HTML>
<BODY>
<OBJECT id=LLISupport PROGID=“LLSupport.Translator”
RUNAT=“Server”></OBJECT>
<H1>Bienvenue au Language Logic</H1>
<H2>Bonjour Charles!</H2>
</BODY>
</HTML>

A key feature of this method is that the translations to any desired language are performed by the user. The user translates the web site by viewing a special page on the site that lists all of the strings used on the site in their English version, with the translation to the preferred language displayed to its right. An example of a portion of that screen is shown below on Table 7. In this case the preferred language for the client is German.

TABLE 7
Übersetzungen
Lokale Identifizierung 1031
Identifizierung der de
Sprache

| | Schlüss | | |
|---|---|---|---|
| Aktionen | el | Englisch | Deutsch |
| [symbol] | 5490 | {-- Copied from %%1 --} | {-- Kopiert von %%1 --} |
| [symbol] | 5491 | {-- Copied to %%1 --} | {-- Kopiert nach %%1 --} |
| [symbol] | 5144 | (No company) | (Keine Firma) |
| [symbol] | 1201 | <A href=‘%%1’>Return to last page</A> | <A href=‘%%1’>Zurück zur letzten Seite</A> |
| [symbol] | 5535 | <P>CFMC conversion complete</P> | <P>CFMC Umwandlung vollendet </P> |
| [symbol] | 5534 | <P>Converting from CFMC Data File...</P> | <P>Umwandlung von CFMC Datei...</P> |
| [symbol] | 5531 | <P>Converting from Excel Data File...</P> | <P>Umwandlung von Excel Datei...</P> |
| [symbol] | 5537 | <P>Converting from Tab Delimited text | <P>Umwandlung von Tab Delimited Textdatei...</P> |
| | | file...</P> | |
| [symbol] | 5530 | <P>Data saved successfully</P> | <P>Daten erfolgreich gespeichert</P> |
| [symbol] | 5536 | <P>Error during conversion of CFMC file<P> | <P>Fehler während Umwandlung von CFMC Datei<F |
| [symbol] | 5532 | <P>Excel conversion complete</P> | <P>Excel Umwandlung beendet</P> |
| [symbol] | 5533 | <P>Excel error during conversion<P> | <P>Excel Fehler während Umwandlung<P> |
| [symbol] | 5529 | <P>Saving input data...</P> | <P>Speichern von Eingabedaten...</P> |
| [symbol] | 5538 | <P>Tab Delimited conversion completed</P> | <P>Tab Delimited Umwandlung beendet</P> |
| [symbol] | 5495 | A column containing the Respondent ID could | Es konnte keine Spalte mit der Antwortendenidentifizi |
| | | not be found<br>Be sure the word SessionID or | gefunden werden<br>Überprüfen Sie, ob das Wort |
| | | RespondentID is the first cell of the column | Sitzungsidentifizierung oder Antwortendenidentifiziert |
| | | containing response identifiers | Zeile der Spalte mit den Antwortidentifizierungen ist! |

The user can edit any translation by clicking the pencil icon to the left. Changes to translations are saved in the database, keyed by client username and numeric string identifier.

The method of the present invention is further described with reference to the following example.

### EXAMPLE

1. Starting.

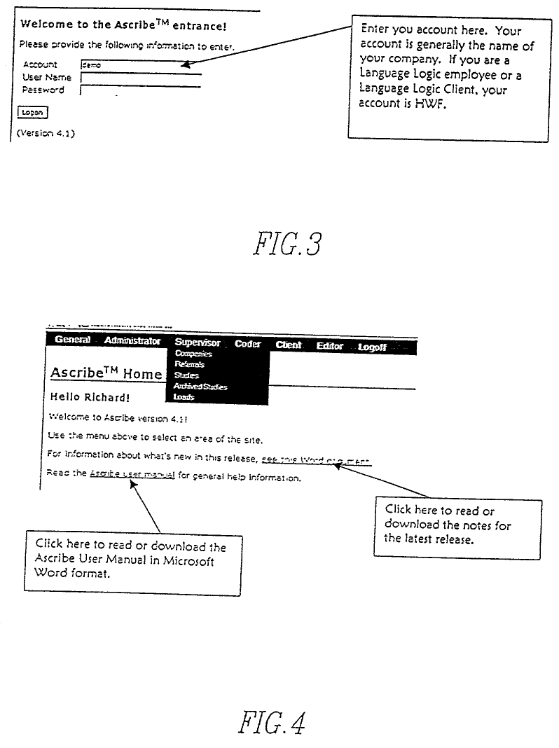

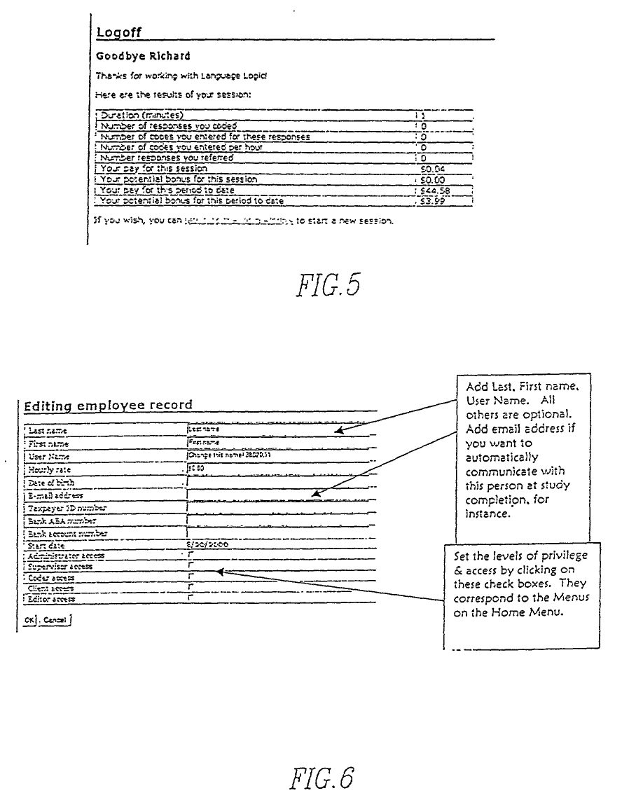

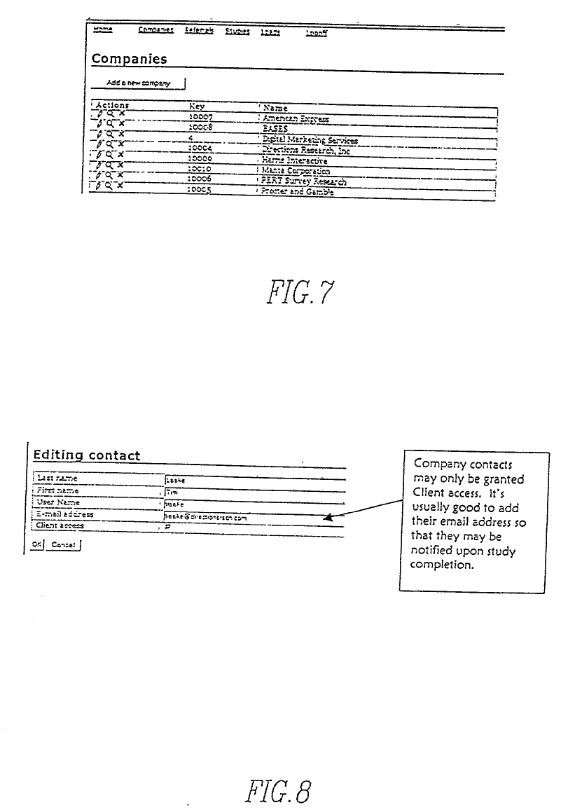

By way of an example, as is shown in FIG. 3, the user is first asked for his user name and password. As is shown in FIG. 4, a home menu may be provided which allows the user to access a user manual and updates thereto. As is shown in FIG. 5, a log off screen may also be provided which provides the user with various information regarding his current session. In FIGS. 6 and 7, the user may also be provided respectively with screens which allow editing of employee information who are authorized to use the system and with company. Such companies may be either clients or clients of clients. Further, as is shown in FIG. 8, a screen may be provided in which company contact information may be edited.

2. Loading Data.

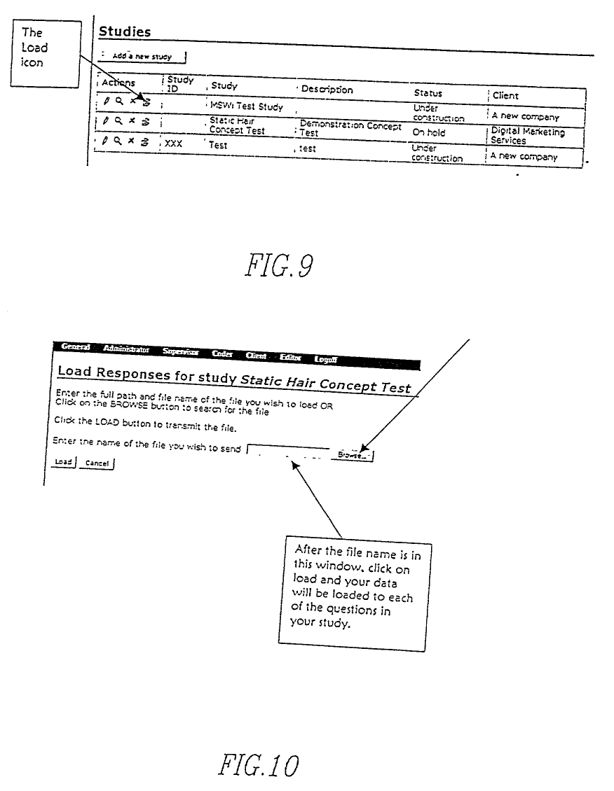

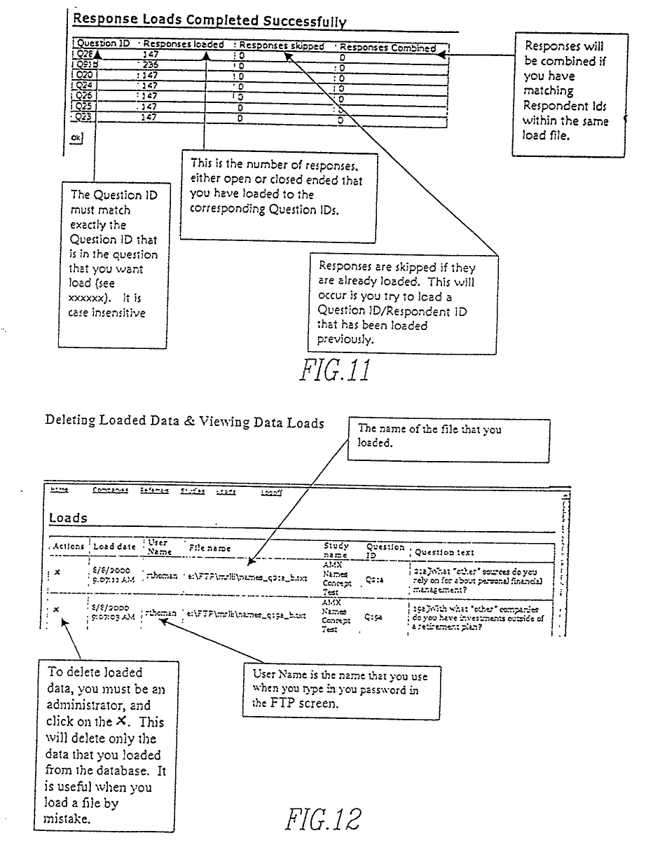

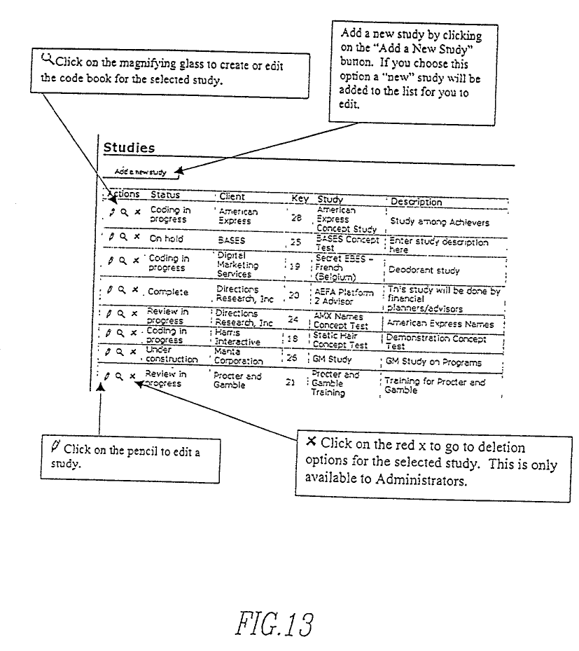

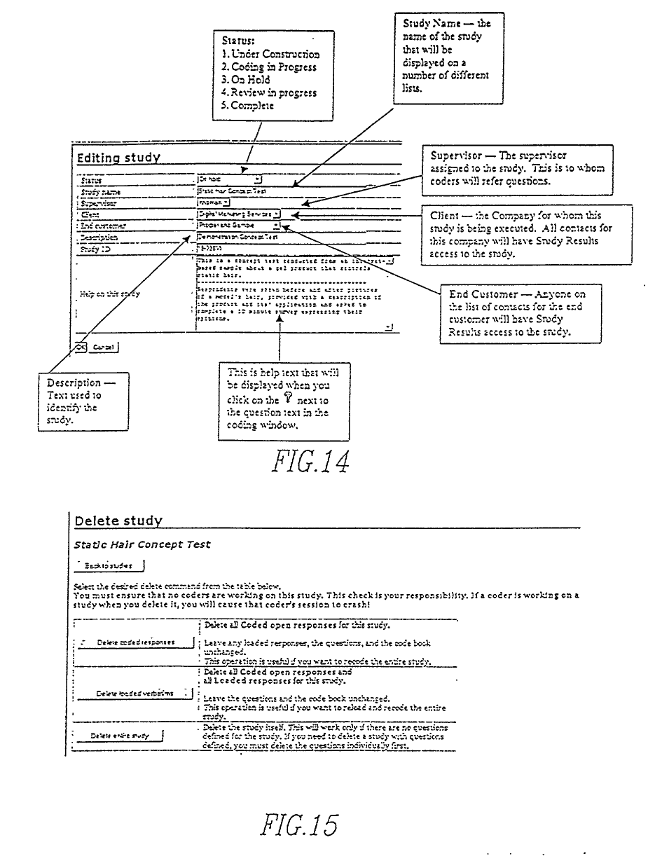

Referring to FIG. 9, to load data to the entire study the person loading the data may sign on to the site and download the data by selecting the study for which data is to be loaded in the clicking of the load icon. The screen change figure will then appear to the user to enable the user to click on the load button, which will load data to each question of the study or this file. After such data has been loaded, a screen similar to FIG. 10 will describe the results of the load. A screen such as FIG. 11 may also be provided to delete loaded data and to view a summary of data loads.

3. Creating a Study and Study Components.

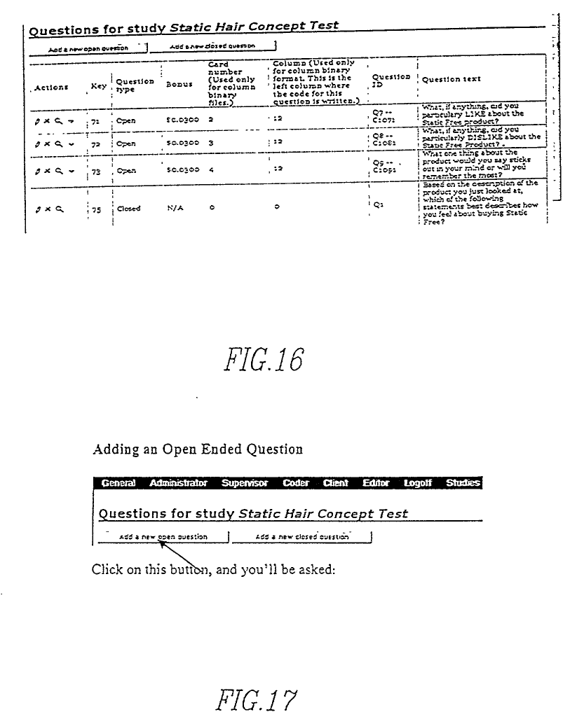

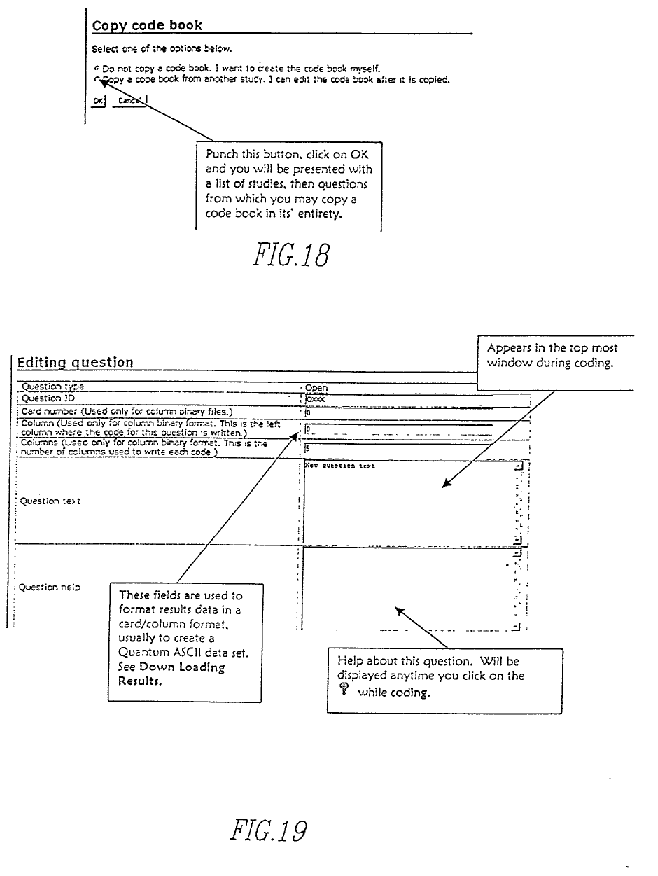

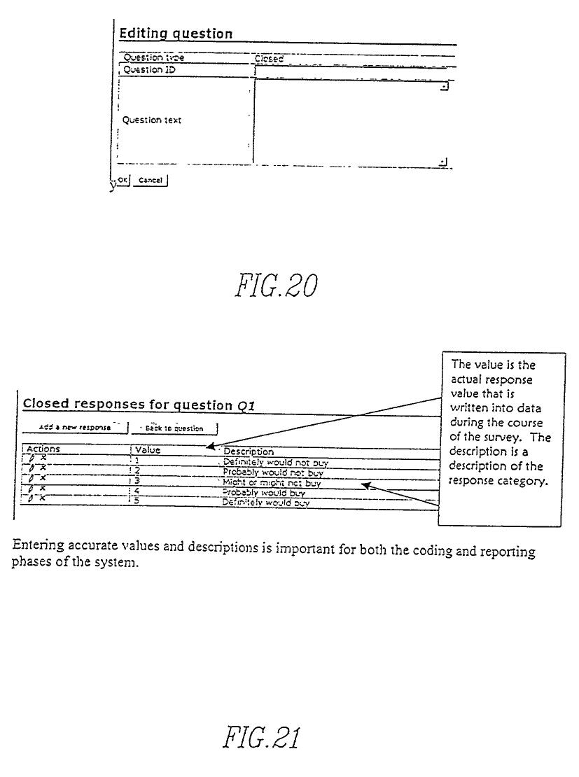

Referring to FIG. 12, a screen may then be provided in which a study is created. On this screen not only may a new study be added but a study may be edited, or a study may be deleted. For editing of a study a screen such as is shown in FIG. 13 may be displayed in which the user may change the status, study name, supervisor, client, and customer a description of the study. Various text information on which may be useful to the user may also be changed. The deletion of the study may be accomplished by means of a screen as shown in FIG. 14. Questions may be added or edited by means of a screen as is shown in FIG. 15. Two basic types of questions may be posed which are open ended questions and closed ended questions. Open ended questions are answered with verbatim text, typed in by the respondent over the internet, described verbally to a phone operator or written. Closed end questions ask for a “discrete” response usually from a list of possible responses. Open ended responses are what is coded for the user. A closed end question provides context about what the respondent has answered in the survey. At times closed end questions are critical to understanding a verbatim response, when for instance the open end question says, “You said X about Y, why did you say that?” Where X and Y are answers to closed end questions in many cases ratings. Closed end questions may also be used in the study analysis function to build tabulated report as is described hereafter. An open ended question may be added by means of a screen as is shown in FIG. 16. The screen shown at FIG. 17 will allow the user to go between creating a new code book or code from another study. After the user has either copied the code book or declined a copy of code book he will be presented with a screen as is shown in FIG. 18 in which he will be able to edit questions. In order to add a closed end question the user will click on “Add a new closed end question” and a screen as is shown in FIG. 19 will appear which will allow the user to enter the closed end question text and question ID. The value of a particular response to a closed question may be shown on the screen shown in FIG. 20. The value of the actual response value that is written into data during the course of the study. The description is the description of the response category.

4. Coding Verbatim Questions.

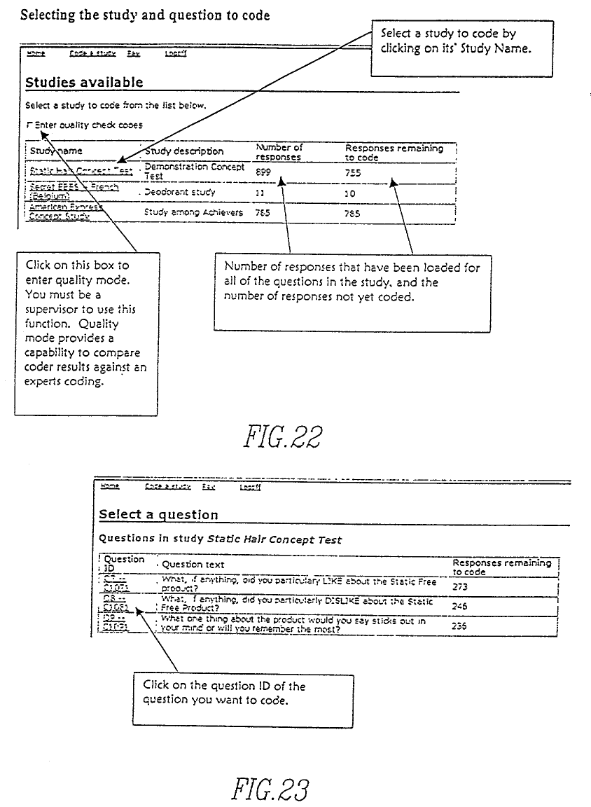

Referring to FIG. 21 in selecting the study and the questions to code, a Studies Available screen is initially displayed. On this screen a quality mode may be selected. The quality mode provides capability to compare coding results against an expert's coding. On this screen the study name will also be identified as will the amount of responses that have been loaded for all the questions in the study and the number of responses not yet coded. FIG. 22 shows the next screen on which the study was selected. FIG. 23 displays a coding window. On this screen the user will be able to click on various categories to see all responses that have been coded with a particular category. The screen also enables the user to click on a particular verbatim response to select that category to code this verbatim response.

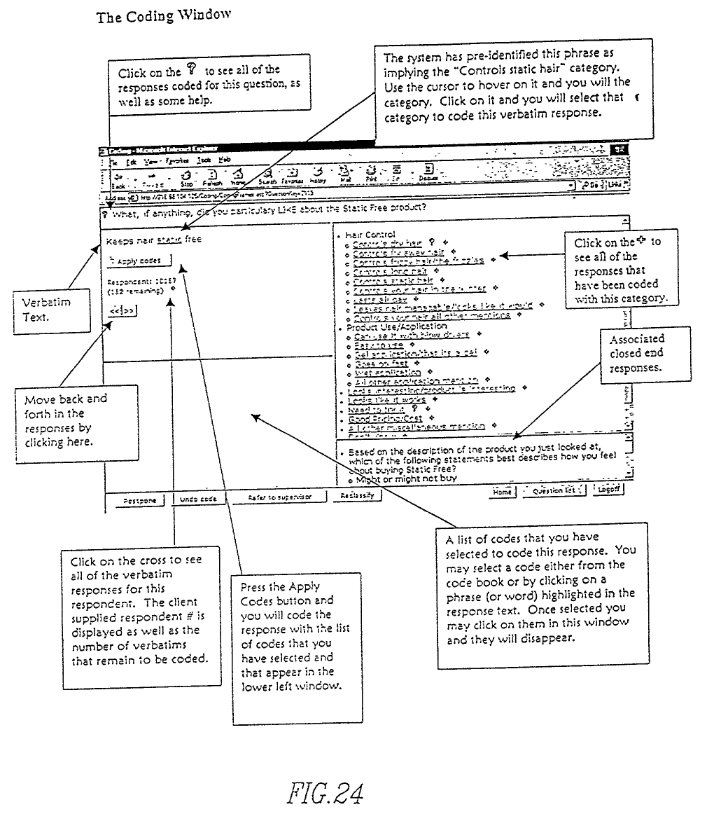

On the “Auto Coding” function on the FIG. 24 automatically codes exact textual matches. That is, when a verbatim is coded and other verbatims for the same question have the exact text they will be coded automatically the same way. For example if the question is “What did you like about the product?” The auto coding function will come into play if the answer is “nothing”. When 200 people have been asked this question, for example, and 80 of them say “nothing”, then as soon as the first coder, codes the first “nothing” response the data base is searched for all other “nothing”, responses and all 80 of these responses are coded with a nothing code.

The user may select the code by either choosing it from the code book in the upper right hand corner of FIG. 23, or if it appears that the system has chosen correctly, chose the underline or bolded text. In any case, the user will double click on his choice and the code will appear in the window directly below the response text window. The used then must click on “Apply Codes” to confirm his choices. If there are multiple ideas expressed in the response text then multiple codes are appropriate.

The system may also be designed so that underlined and bolded text in the open ended response means that the text is probably associated with the coding category.

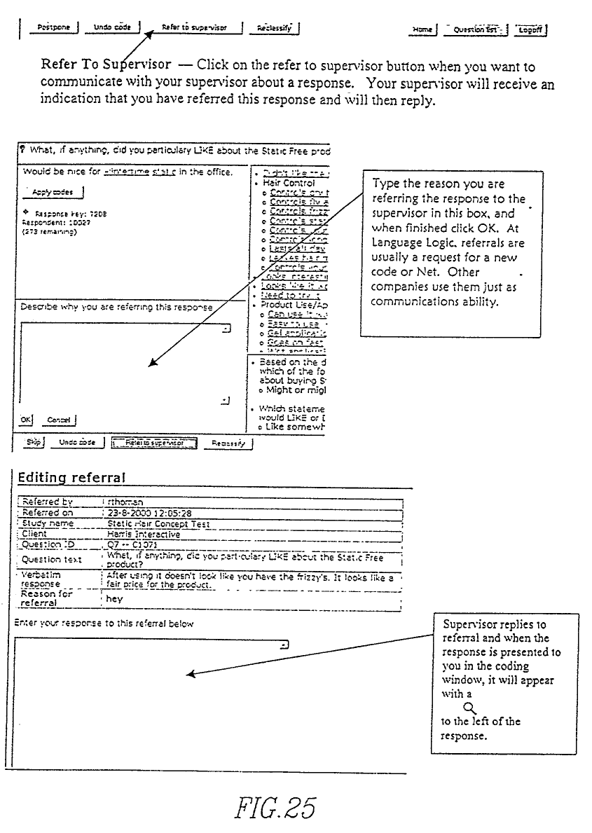

The “Undo Code” function shown on FIG. 25 allows the previous code that was applied to be disregarded. The user may undo as many codes as he applies during a single session, If the user undoes the code previously applied, the system assumes that he skipped a response.

The user may also go to the home page at any time. The user may view the question list, i.e. “Chose Another Question”, at any time. The postponed responses are used when the user does not want to code this response until all others have been coded.

Referring to FIG. 24, the screens are shown in which the user may refer a response in a box to his supervisor in which the supervisor replies to the referral.

Referring to FIG. 25, a screen is shown in which a function is provided to allow the user to reclassify the response to another question. For instance, to reclassify a “likes” verbatim response has been made or to a “dislikes” question to likes question when the user clicks on the reclassified button, a window will appear with identifiers for all the questions in the study.

5. Building a Code Book.

The code book is a list of categories that the coder will chose from when coding a response. It applies to a single question. The code book is also referred to as the code frame or the code method. There are a number of important terms and concepts in the system of the present invention. A “Code Dictionary” is a data base that stores all the code books. It is important that the Code Dictionary structure be designed to ensure quick access to the codes, typically code book templates in repetitively used code books are stored in the Code Dictionary. A “Code Book” refers to codes that are used as a specific questions in a specific study. They may be copied from a question that already has a code book definition or from the dictionary of codes. The user may also build the question indirectly. Both code books and code dictionaries are stored and displayed in a hierarchy of parent and children.

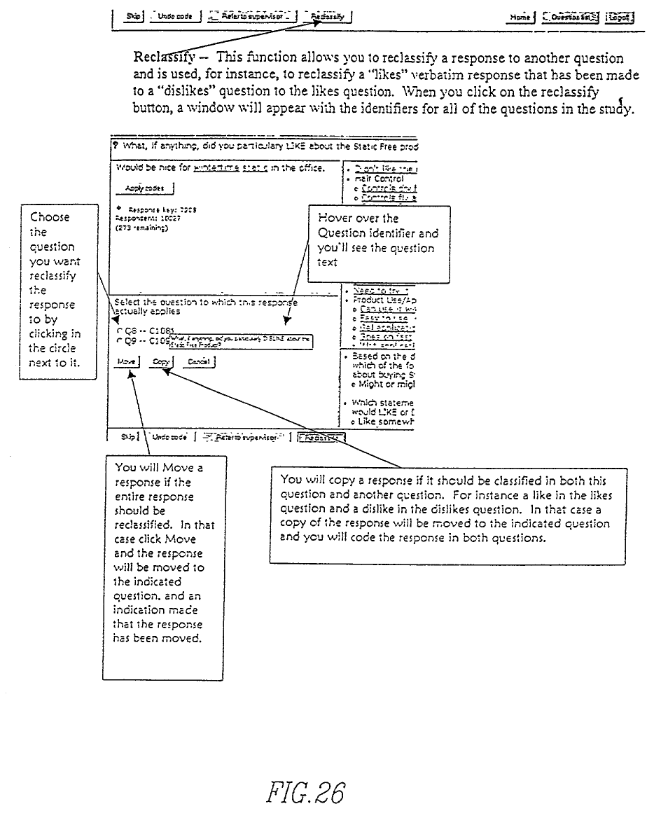

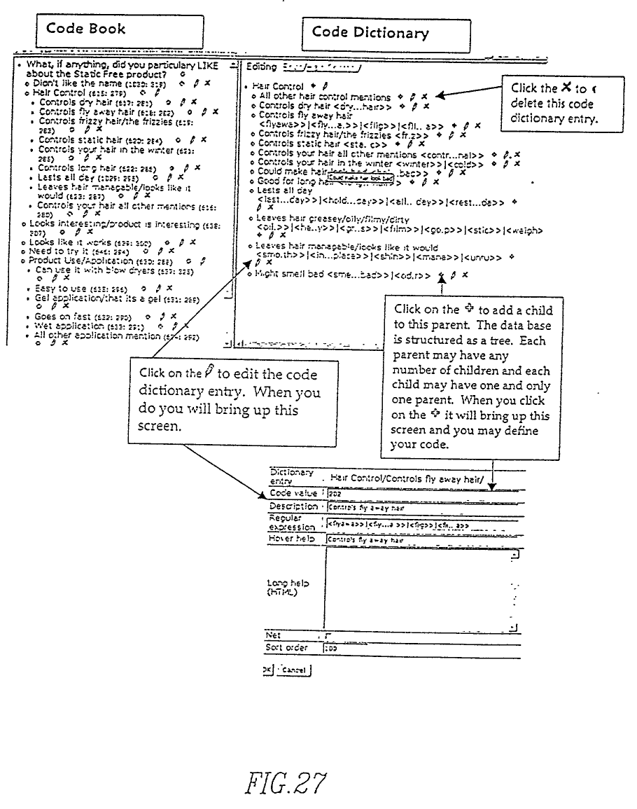

Referring to FIG. 26, a screen is shown by means of which the code dictionary is built. When the user edits a code book, the code dictionary always appears on the right side of the screen. FIG. 27 is a further screen used in building the code book. On the left side of the screen there is a question code book. These are the codes that will be used to code the question. They are copied from the code dictionary and placed “In the Question”. The user may change them to be specific to the question once they have been copied from the code dictionary. On the right side of the screen shown in FIG. 27 there is a code dictionary which is a data base of codes. These codes may be thought up as main “ideas” that will make a specific to a question after the user has copied them to a question. On the screen the red dot is a copy symbol, the pencil is an edit symbol, the X is a delete symbol and the opening file symbol means to copy all the children of a parent.

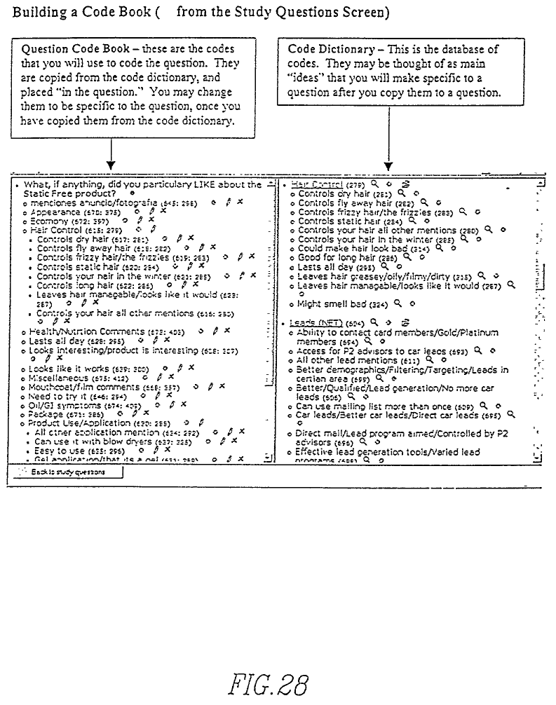

Referring to FIG. 28 a screen is shown by means of which a question code book may be created. That is after the open ended question has been created the user may begin to develop the code book for that question. In many cases the user will change codes, and he can use the code book by coping them into the code book, in other cases the user may have to entirely generate the question code book by creating the codes in the code dictionary and then copying them to the code book and making modifications to them.

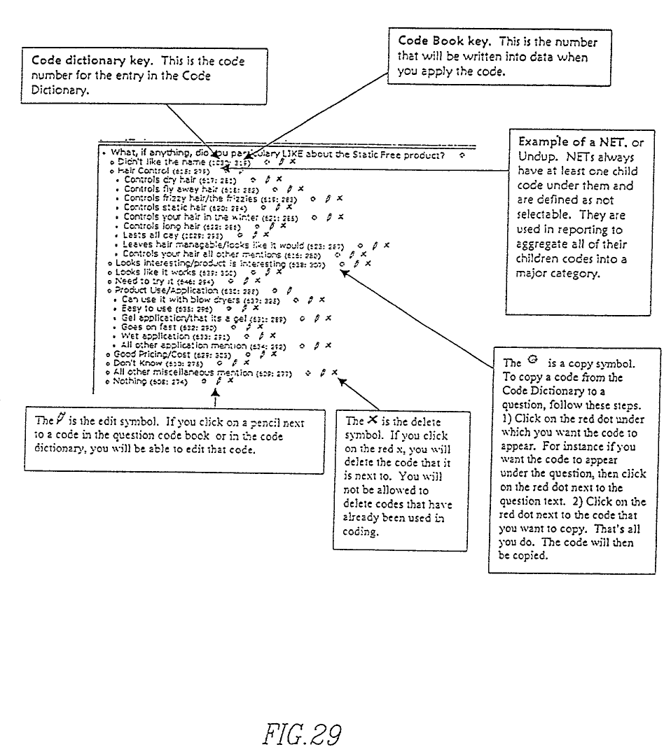

Referring to FIG. 29 a further screen for generating the code is displayed.

7. Re-Coding.

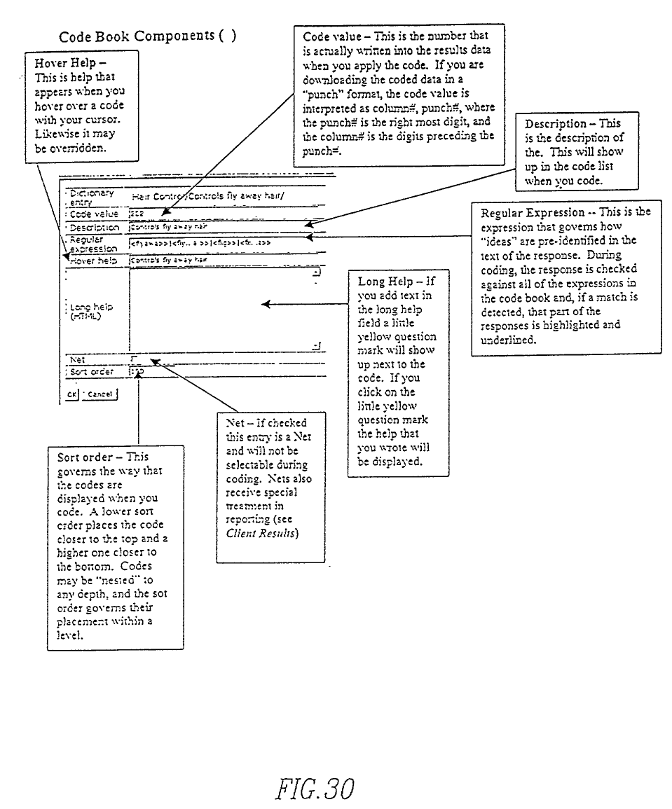

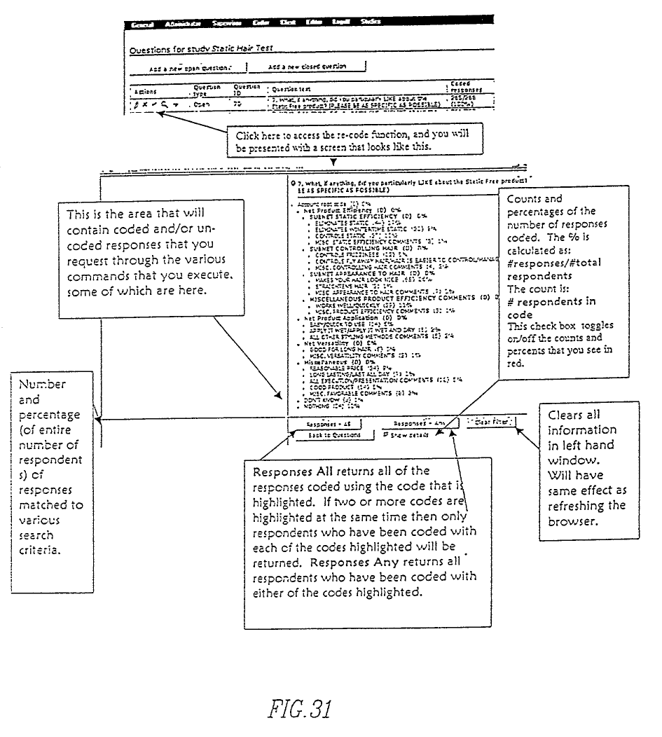

The three main reasons to perform the re-coding allows the codes to be checked. Secondly, the code books may be built through a quantitative examination of the ideas contained in the verbatim responses for each question. Finally, re-coding may used as an advance mode of coding of and can reduce the coding from brand list from hours to minutes. Re-coding can also be used to test expressions, code brand list quickly, delete codes, add codes to the code book, edit codes in the code book, re-net or move codes from one net to another, copy and paste a code book from MS Word or exchange one code in the response for another. Which may be used as such re-coding as shown in FIG. 30.

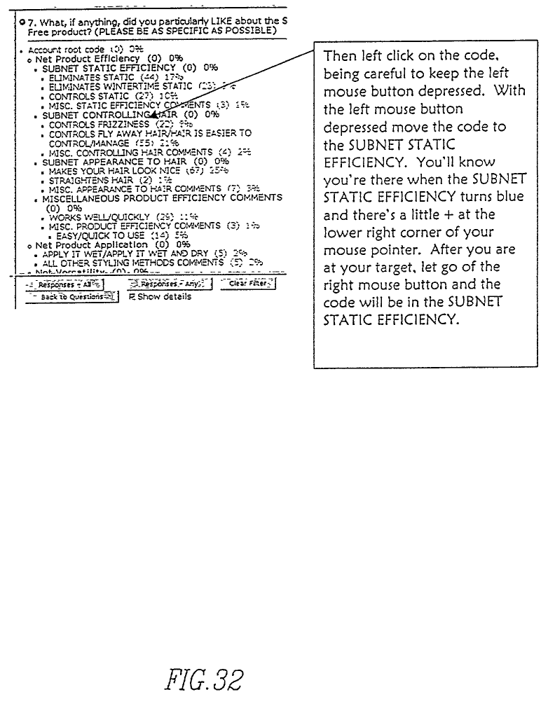

Referring to FIG. 32 a screen is shown in which the re-coding employs “Drag & Drop” technique. To allow a code to be moved from one sub-net to another.

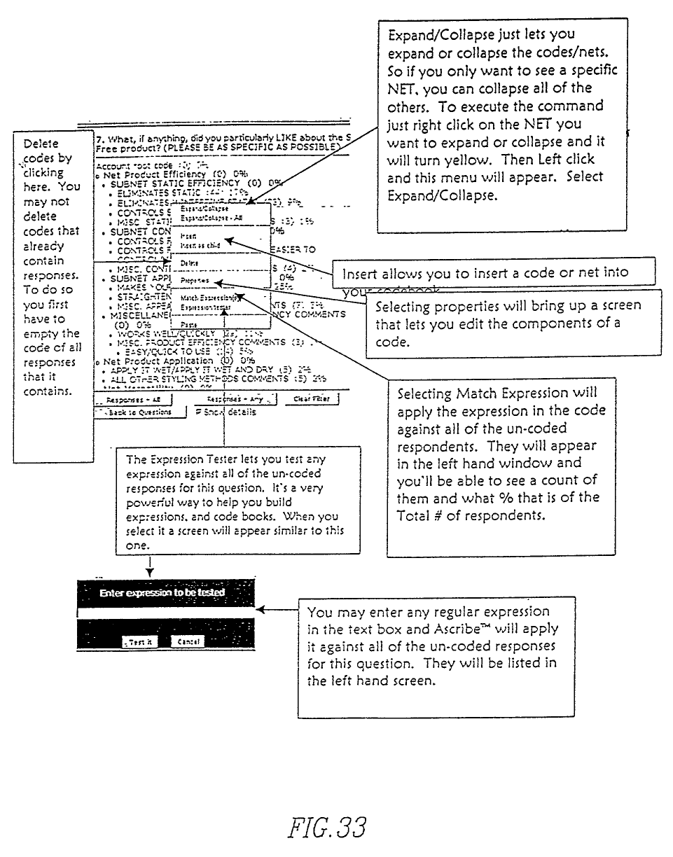

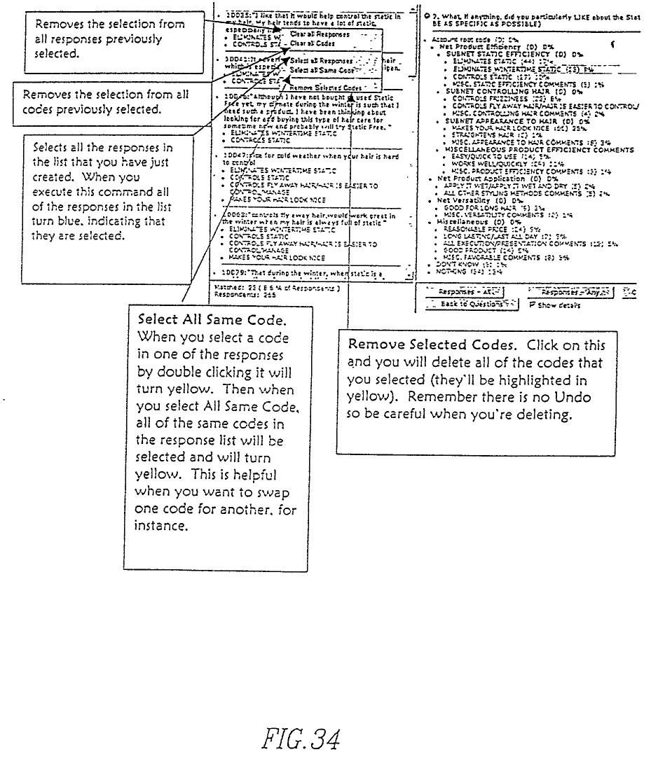

Referring to FIGS. 33 and 34 screens are shown which enable the user to re-code functionality and manipulate the code book. In FIG. 33 the user will click on and highlight a code or a net and then right click to bring up the menu shown in that figure. In FIG. 34 the screen is shown in which the left hand side of the screen contains responses that the user selected either through an expression tester or by asking to see responses for a code or set of codes. After the list is on the left hand side window the user may right click the menu illustrated on the figure. In the example shown in FIG. 34, the user asks for all respondents that were coded with “eliminates winter time static”.

In order to re-code the user sets up the code book so that he has tabs to represent his net structure. For example, the format in the user's notepad could be as shown in the following Table 8.

TABLE 8
NET 1

Code1
Code2
Code3
Coden

NET2

Code1
Code2
Code 3
Coden

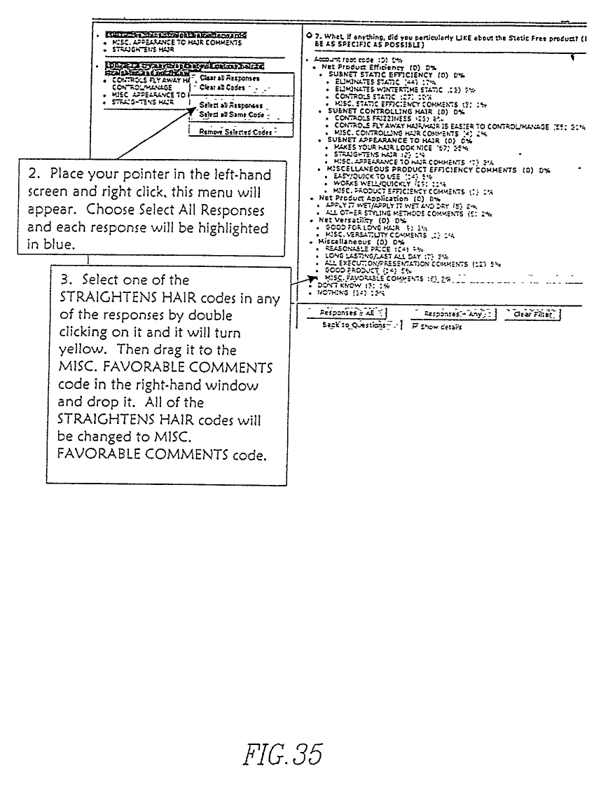

User can use sub-nets to any level but must make certain that tabs are used to sub-net form nets, from codes. The user copies a formatted text by highlighting and executing the copy command. The user selects insertion of the codes and the codes are inserted into his code book. He will then need to fill in any other code information by selecting codes, right clicking and selecting properties. Referring to FIG. 35, the screen is shown which allows the exchange of one code for another. For example, the user may want to change all the responses that are coded with “straightens hair” to “misc. favorable comments” because the percentage of people mentioning “straightens hair” is too low at 1%. To effect the change, in the right hand window, the user highlights the “straightens hair” and presses the “responses all” button at the bottom of the screen. All the responses coded with “straightens hair” will appear in the left hand window.

A new code may also be created from a combination of codes. For example, if the user wishes to create a new code “really, really easy”, for all the respondents who are coded with both “works well/quickly” and “easy/quick to apply”. In such a code the following procedure would be followed. The user would highlight both “works well/quickly” and “easy/quick to apply”. He would then click on the “responses any” button he would see a list of all responses that have both codes. The user then would then make a code called “really, really easy”. With the code each of the responses displayed in the right hand window by dragging the “really, really easy” code to each of the responses. If the user wanted to delete the codes from the responsor he would highlight code that he wants he wants to delete and double clicking on them and right click and choose delete.

7. Regular Expressions.

A regular expression is a pattern used to match text. Each code in a code book can have an associated regular express. When a verbatim response is displayed to a coder, it is first compared to each regular expression defined in the code book for the question. If a match is found the matching text is underlined and highlighted. If the coder clicks on the underlined text, the code that matches the text is selected.

For simple regular expressions, the user should never use upper case letters in the regular expression. Matching is always sensitive. Letters and digits in the regular expression matched the corresponding text in the verbatim response as is, for example, shown Table 9 below. It will be seen in this Table 9 these regular expressions simply match the same sequence of characteristics in the verbatim text.

TABLE 9

| Verbatim response | Regular expression | Result |
|---|---|---|
| I love cats | love | I love cats |
| I love dogs | dog | I love dogs |
| I LOVE DOGS | o | I LOVE DOGS |

In matching words the user would use angle brackets around the characteristics to mean “match this word” as is for example shown in Table 3 below. It will be noted that the first regular expression matches the “cat” in “Catawba”, which is probably not the desire results. By putting “cat” in angle brackets we match only that exact words.

TABLE 10

| Verbatim response | Regular expression | Result |
|---|---|---|
| The cat likes Catawba | cat | The cat likes Catawba |
| melon | | melon |
| The cat likes Catawba | <cat> | The cat likes Catawba |
| melon | | melon |

Often the user may want to match words that begin with a certain sequence of characteristics. In this case two angle brackets are used at the end of each work to mean “match that word that begins with these characters” as is for example shown in Table 11 below.

TABLE 11

| Verbatim response | Regular expression | Result |
|---|---|---|
| I like Cadillacs and | <cad>> | I like Cadillacs and |
| Catalinas | | Catalinas |
| I like Cadillacs and | <ca>> | I like Cadillacs and |
| Catalinas | | Catalinas |

The user can also match words that end with a certain sequence of characters. The user would use two angle brackets at the start to the words to mean “match words that end with these characters” as is for example shown in Table 12 below.

TABLE 12

| Verbatim response | Regular expression | Result |
|---|---|---|
| I use USMail, email, and | <<mail> | I use USMail, email, and |
| SnailMail | | SnailMail |
| I use US Mail, e-mail, | <<mail> | I use US Mail, e-mail, |
| and Snail Mail | | and Snail Mail |
| I use US Mail, e-mailing, | <<mail> | I use US Mail, e-mailing, |
| and Snail Mail | | and Snail Mail |

It will be noted that in the above examples that the definition of a word matching is a continuous sequence of characters. Word matching stops at punctuation marks and spaces.

Finally the user may also use two angle brackets to start at the end of a word to mean “match words that contain these characters” as is for example shown in Table 13 below.

TABLE 13

| Verbatim response | Regular expression | Result |
|---|---|---|
| I send mail by USMailing, | <<mail>> | I send mail by |
| emailing and SnailMail | | USMailing, emailing, |
| | | and SnailMail |

It is critical that opening angle brackets are matched with the closing angle brackets. Any of these examples would cause a regular expression matching not to work as is shown in Table 14 below.

TABLE 14

>cat<
<cat
cat>>

To help make the use of regular expressions easier, the verbatim response is “normalized” before it is compared to the users regular expressions. The type of normalization depends on the language that the user selects for his browser. For English, normalizations shown in Table 15 are performed.

TABLE 15

| This word in the verbatim | |
|---|---|
| response | Is replaced with this word |
| 1st | first |
| 2nd | second |
| 3rd | third |
| can not | cannot |
| dont | do not |
| do'nt | do not |
| wont | will not |
| wo'nt | will not |
| isnt | is not |
| is'nt | is not |
| n't | not |
| cuz | because |
| & | and |

The result of these normalizations is displayed on the coders screen and it also used for regular expression matching. For western languages other than English, are the normalizations shown on the following Table 16.

TABLE 16

| These characters in the | Are converted to these |
|---|---|
| verbatim response | characters |
| àáâää\dot{a} | a |
| [symbol] | c |
| èéêë | e |
| ìíîï | i |
| \overline{n} | n |
| òóôöö | o |
| ùúûü | u |

The results of these normalizations are not found on the codes screens but are useful for expression matching. The user will, therefore, not use characters with diacritical marks in regular expressions. The user will use letters without the diacriptical. Thus, such letters will match the same letter in the verbatim response, with or without diacriptical block.

To match phrases the uses the same phrase inside angle brackets as is for example shown in the following Table 17.

TABLE 17

| Verbatim response | Regular expression | Result |
|---|---|---|
| I love cats | <love cat>> | I love cats |

The user can match phrases that are bonded by certain words. The user will use three dots in the regular expression to mean “skip up to 30 characters” as is shown for example in Table 18. It will noted that the third and fourth examples in Table 18 do not give the desired result the third one matched but the phrase is not the intended phrase, the fourth did not match because of comma between “love” and “cats”.

TABLE 18

| Verbatim response | Regular expression | Result |
|---|---|---|
| I love cats | <love . . . cat>> | I love cats |
| I love white cats | <love . . . cat>> | I love white cats |
| I love dogs and hate cats | <love . . . cat>> | I love dogs and hate |
| | | cats |
| I love dogs, cats, and mice | <love . . . cat>> | I love dogs, cats, and |
| | | mice |

In order to match negative phrases the user can use the character ˜ directly in front of < or << to match the word or “not in the preceding portion of the phrase” this is a shorthand for <not>. It should be remembered that in English the contraction “in't” is changed to “not” so that the user does not have to be concerned about matching the contraction. An example of such matching same is shown in Table 19 below.

TABLE 19

| Verbatim response | Regular expression | Result |
|---|---|---|
| I love cats | ˜<love . . . cat>> | I love cats |
| I don't love white cats | ˜<love . . . cat>> | I do not love white cats |

In order to handle misspellings of words, single dot character matches any character in that location. This technique may be used as is for example shown in Table 20 below.

TABLE 20

| Verbatim response | Regular expression | Result |
|---|---|---|
| Cadillacs and Catalinas | <cad.l>> | Cadillacs and Catalinas |
| Cadallacs and Catalinas | <cad.l>> | Cadallacs and Catalinas |

An example of matching a commonly misspelled word that has characteristics missing is shown in Table 21 below.

TABLE 21
An example of matching a commonly misspelled word that has characters
missing.

| Verbatim response | Regular expression | Result |
|---|---|---|
| Niether this nor that | <n.{1, 2}ther> | Neither this nor that |
| Nither this nor that | <n.{1, 2}ther> | Nither this nor that |
| Nether this nor that | <n.{1, 2}ther> | Nether this nor that |

The practice of the invention as related above are sufficient for most uses. There are, however, additional practices that may be incorporated into the invention in which special characteristics, is described in the following Table 22 may be used to build more complex regular expressions.

TABLE 22

| Character | Description |
|---|---|
| \ | Marks the next character as either a special character or a |
| | literal. For example, “n” matches the character “n”. |
| | “\n” matches a newline character. The sequence “\\” |
| | matches “\” and “\(” matches “(”. |
| \hat{ } | Matches the beginning of input. |
| S | Matches the end of input. |
| * | Matches the preceding character zero or more times. For |
| | example, “zo*” matches either “z” or “zoo”. |
| ÷ | Matches the preceding character one or more times. For |
| | example, “zo÷” matches “zoo” but not “z”. |
| ? | Matches the preceding character zero or one time. For |
| | example, “a?ve?” matches the “ve” in “never”. |
| . | Matches any single character except a newline character. |
| (pattern) | Matches pattern and remembers the match. The matched |
| | substring can be retrieved from the resulting Matches |
| | collection, using Item [0]. . . [n]. To match parentheses |
| | characters (), use “\(” or “\)”. |
| x\|y | Matches either x or y. For example, “z\|food” matches “z” or |
| | “food”. “(z\|f)oo” matches “zoo” or “food”. |
| {n} | n is a nonnegative integer. Matches exactly n times. For |
| | example, “o {2}” does not match the “o” in “Bob,” but |
| | matches the first two o's in “foooood”. |
| {n,} | n is a nonnegative integer. Matches at least n times. For |
| | example, “o {2}” does not match the “o” in “Bob” and |
| | matches all the o's in “foooood.” “o {1,}” is equivalent to |
| | “o÷”. “o {0,}” is equivalent to “o*”. |
| {n,m} | m and n are nonnegative integers. Matches at least n and at |
| | most m times. For example, “o {1,3}” matches the first three |
| | o's in “fooooood.” “o {0,1 }” is equivalent to “o?”. |
| [xyz] | A character set. Matches any one of the enclosed characters. |
| | For example, “[abc]” matches the “a” in “plain”. |
| [\hat{ }xyz] | A negative character set. Matches any character not enclosed. |
| | For example, “[\hat{ }abc]” matches the “p” in “plain”. |
| [a-z] | A range of characters. Matches any character in the specified |
| | range. For example, “[a-z]” matches any lowercase alphabetic |
| | character in the range “a” through “z”. |
| [\hat{ }m-z] | A negative range characters. Matches any character not in |
| | the specified range. For example, “[m-z]” matches any |
| | character not in the range “m” through “z”. |
| \b | Matches a word boundary, that is, the position between a |
| | word and a space. For example, “er\b” matches the “er” in |
| | “never” but not the “er” in “verb”. |
| \B | Matches a nonword boundary. “ea*r\B” matches the “ear” |
| | in “never early”. |
| \d | Matches a digit character. Equivalent to [0-9]. |
| \D | Matches a nondigit character. Equivalent to [ 0-9]. |
| \f | Matches a form-feed character. |
| \n | Matches a newline character. |
| \r | Matches a carriage return character. |
| \s | Matches any white space including space, tab, form-feed, etc. |
| | Equivalent to “\f\n\r\t\v]”. |
| \S | Matches any nonwhite space character. Equivalent to |
| | “[ \f\n\r\t\v]”. |
| \t | Matches a tab character. |
| \v | Matches a vertical tab character. |
| \w | Matches any word character including underscore. Equivalent |
| | to “[A-Za-z0-9. . .]”. |
| \W | Matches any nonword character. Equivalent to |
| | “[\hat{ }A-Za-z0-9. . .]” |
| \num | Matches num, where num is a positive integer. A reference |
| | back to remembered matches. For example, “(.)\1” matches |
| | two consecutive identical characters. |
| \n | Matches n, where n is an octal escape value. Octal escape |
| | values must be 1, 2, or 3 digits long. For example, “\11” and |
| | “\011” both match a tab character. “\0011” is the equivalent |
| | of “\001” & “1”. Octal escape values must not exceed 256. If |
| | they do, only the first two digits comprise the expression. |
| | Allows ASCII codes to be used in regular expressions. |
| \xn | Matches n, where n is a hexadecimal escape value. |
| | Hexadecimal escape values must be exactly two digits long. |
| | For example, “\x41” matches “A”. “\x041” is equivalent to |
| | “\x04” & “1”. Allows ASCII codes to be used in regular |
| | expressions. |

In order to match multiple cases the user can join regular expressions together using a vertical bar. The vertical bar means “match either of these expressions”. An example of this practice is shown in Table 23 below. The user should only use the vertical bar to separate the words surrounded by angle brackets unless he is using the advanced features described in the next paragraph.

TABLE 23

| Verbatim response | Regular expression | Result |
|---|---|---|
| I love cats | <love . . . cat>>\|<love . . . dog>> | I love cats |
| I love dogs | <love . . . cat>>\|<love . . . dog>> | I love dogs |

8. Study Results

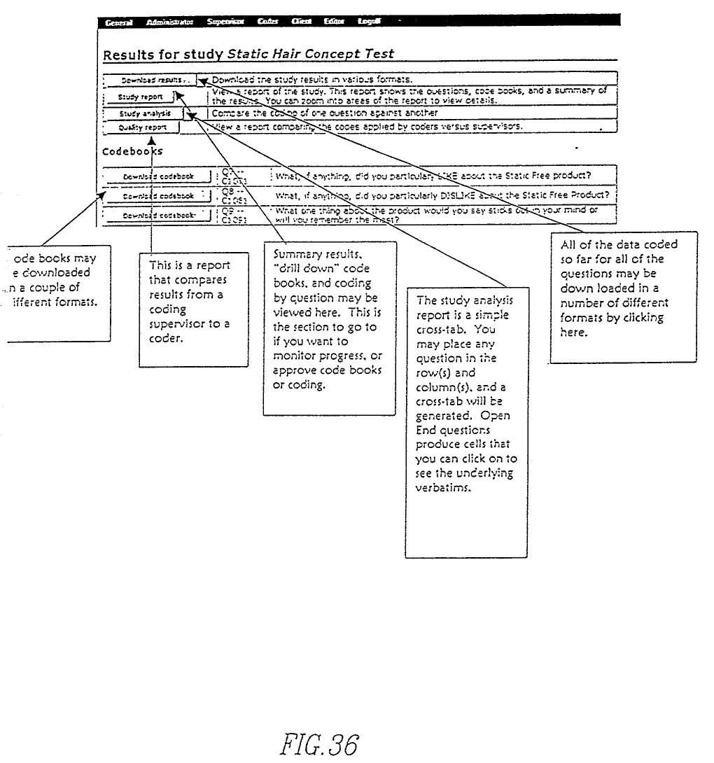

Referring to FIG. 36 a screen with study results are displayed. Whatever portion of client results section that is accessed is displayed in “real time” this information is pulled directly from the data base and includes all data/information in the data base at the time the report was generated.

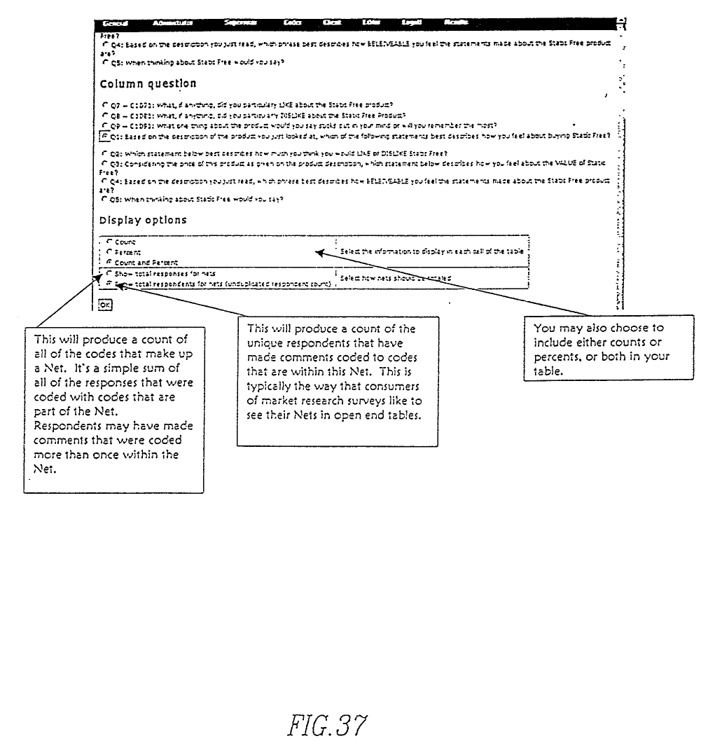

Referring to FIG. 37 a screen with a cross tab study analysis report is displayed this is a simple cross tabulated report primarily intended for account executives and clients but also useful to the user when checking tables. A question in placed in rows and a question in the columns. User then presses go and is presented with a cross tab. If the user places an open ended question in the rows he may click on any of the resulting cells and review the view the underlined column of verbatim responses. This arrangement is considered to be a superior method of presenting verbatim responses to static tables and enables a client or account executive to see, in the response in words, why they responded to various closed end questions. To create the report the user clicks on a question that will appear in the rows and one that will appear in the columns then chooses a display option that is desired.

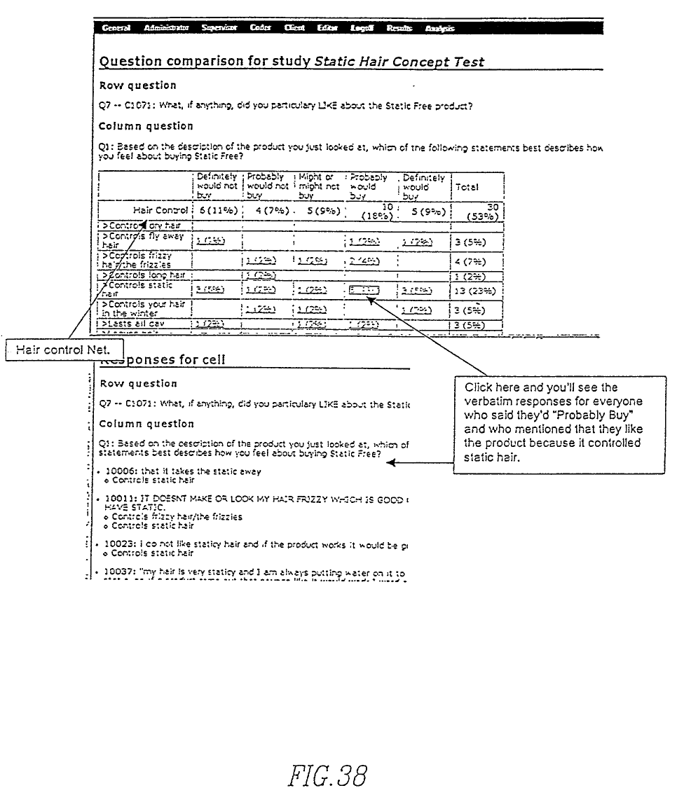

Referring to FIG. 38, a screen with a study analysis report is shown in which cross tabs are created from the collective data. Typically an open ended question is placed in the row and the close ended question in the columns. The user may cross tab closed against closed, open against open, and any combination of the two. When the user places an open ended question in the rows, the resulting cells will contain hyper-links to the underlying verbatim response that make up the cell.

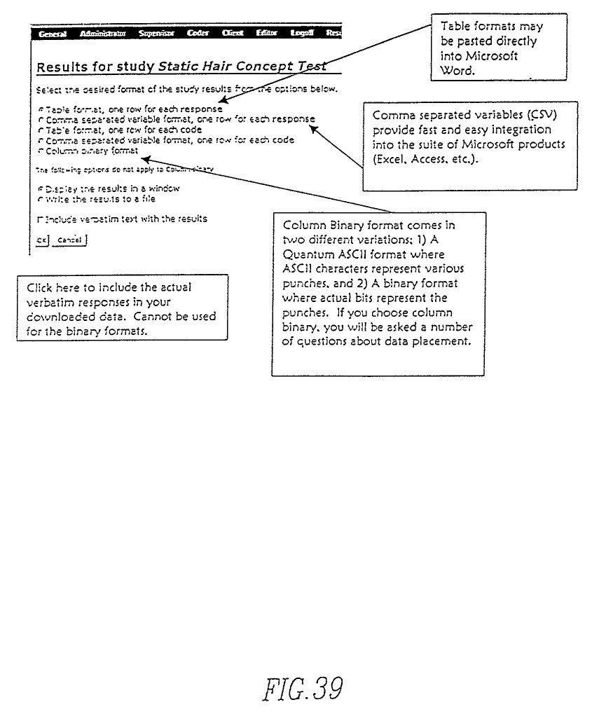

Referring to FIG. 39, a screen is displayed where results are down loaded in any number of formats. If the user choose column binary, the codes may be interpreted as column/punch [e.g. 141=column 14, punch 1]. The user may also chose the actual verbatim in any available data format. For larger files the user may write the results to a file and down load the file.

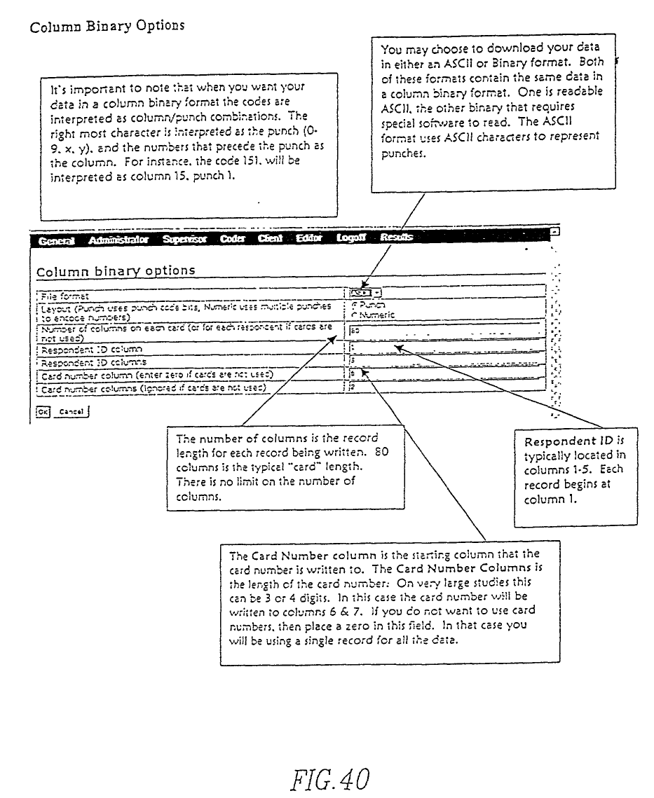

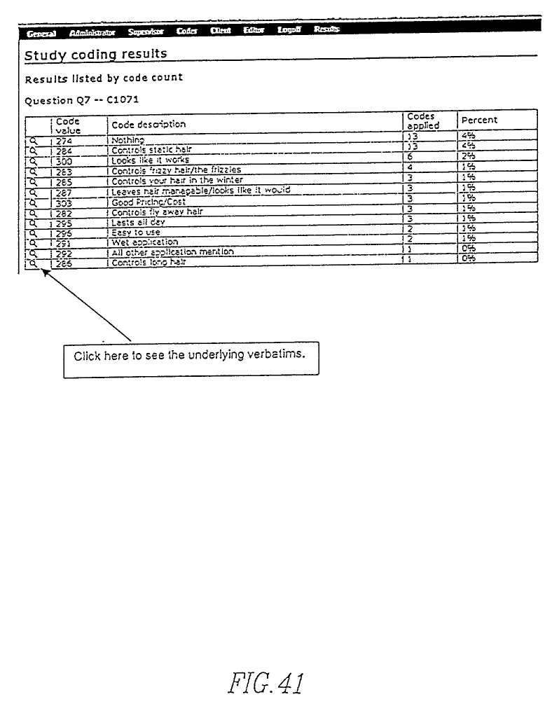

Referring to FIG. 40, a screen that is showing column binary options is shown. The user may choose to down load data in either ACSII or binary format. Both of these formats contains the same data in a column binary format. One is readable ACSII the other binary that requires additional software well known to those skilled in the art to read. The ACSII format uses ACS II characters to represent punches. It will be noted that when the user wants to display data in a binary format the codes are interpreted as column/punch combinations. The right most characteristic is interpreted as the punch [0-9, x, y] in the numbers that proceed to punch as the column. For instance, the code 151 as column 15, punch 1. When down loading the data using the binary option it will be written in what is referred to as 1130 column binary. This refers to the bit configuration in the resulting two-byte words. To read the file using a utility called MTR used as syntax in the following Table 24.

TABLE 24

| mtr -1 -r192 -b192 -i<filename> -o<filename | |
|---|---|
| Where | r=the record length |
| | b=blocking factor |
| | i=input filename |
| | o=output file name |

Referring to FIG. 41, a screen showing study coding results is shown. The report shown in this screen would be primarily intended for coding supervisors and project directors. Some account executives and clients may find it useful as well. For each code in the code frame, amounts and percentages are displayed. The code frame itself is sorted in order of mention and the user may click on the magnifying glass to view the underlying verbatims. Such review would be useful in approving code books and monitoring coding quality. The user may also view this report in the order in which the code frame was developed.

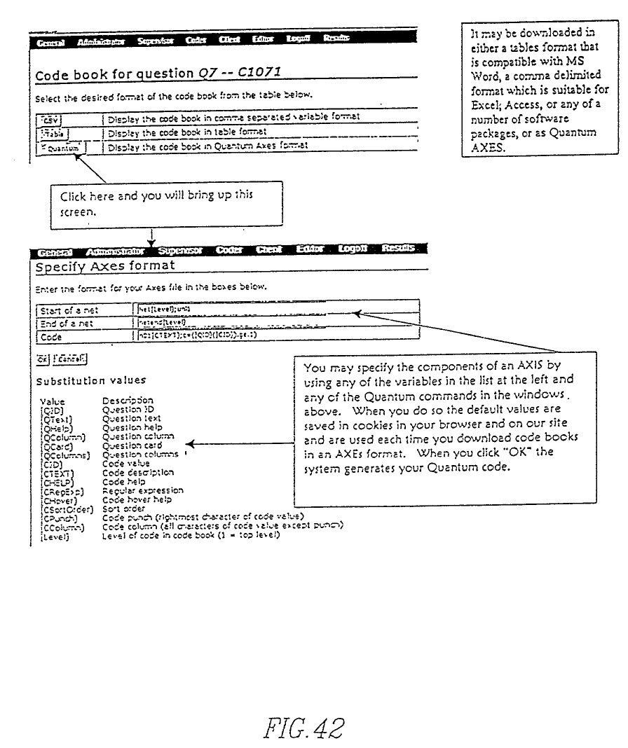

The code books may also be down loaded at any time and in real time. Referring to FIG. 42, it will be seen that there are 3 different formats available which are: [1] A table that the user can cut and paste directly into Microsoft Word, [2] A comma separated variable, a common data interface to Excel, Access, or any number of different software packages, or [3] Quantum AXES if the user chooses Quantum AXES, the system will generate a file that contains the Quantum specifications for creating that table. Such a procedure generally saves from about 1 to 3 hours of tabulation department time.

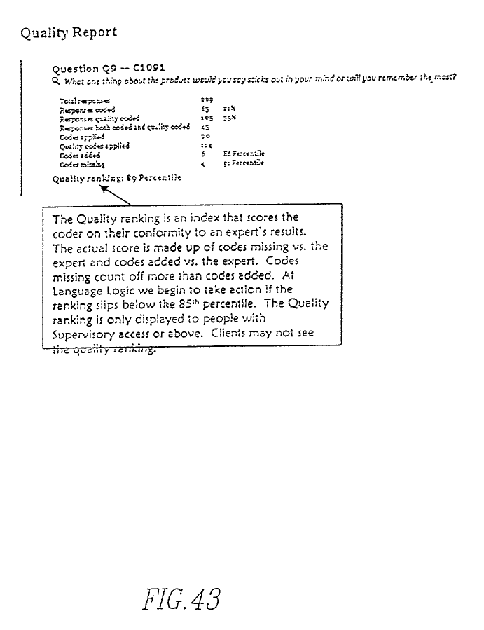

Referring to FIG. 43, a screen showing a quality report is also provided. The quality ranking is an index that scores the coder on his conformity to an experts results. The actual score is made up of a coder's missing versus the expert and code added versus the expert. Codes missing count off more than codes added. It may be desirable to take corrective action with regard to a particular coder if the ranking slips below the 85^{th} percentile. The quality ranking would ordinarily only be displayed to people with supervisory access or above, and clients would ordinarily would not see the quality ranking.

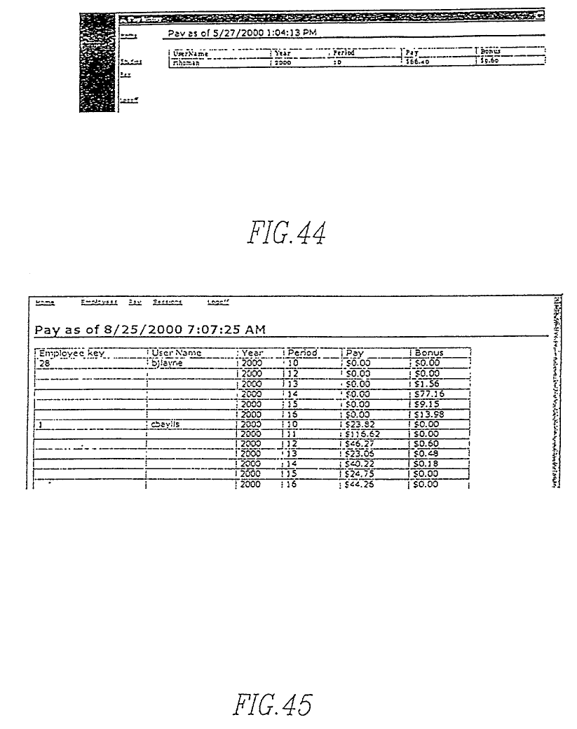

Referring to FIGS. 44 and 45, the screens are also shown which contain reports of productivity and pay history. Each user's time is tracked from log on. When the user logs off after a job, the screen will show the number of responses that had been coded, skipped and refered to a supervisor. The screen will also show how long the user had logged on to the system. If the user were to get logged off or disconnected from the system, all he would have to do is log on again and it will start timing all over. The screen 45 is provided as a summary for supervisors to see pay for all the employees.

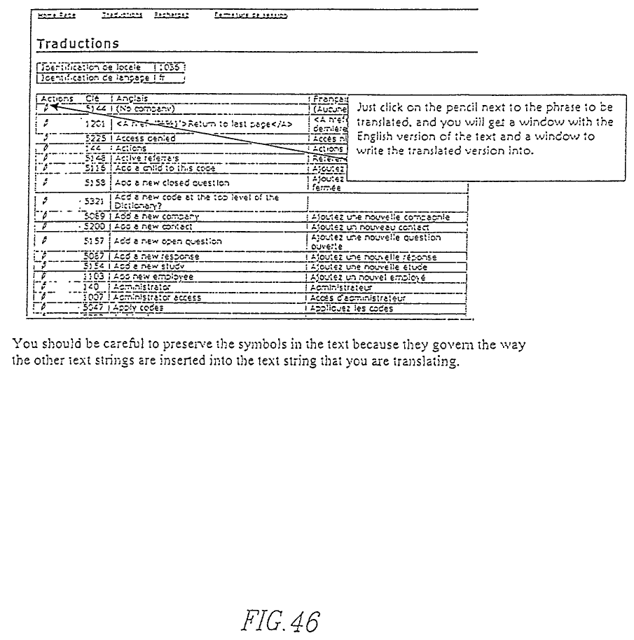

Referring to FIG. 46, a screen is shown which facilitates translating the site. The system is preferably fully language capable and would be able to support a number of European languages. The user may also translate the site by having editor access and clicking on the translations menu item. The language that the site is translated into must be the language of preference for the users internet browser.

To minimize any inaccuracies which may result from cultural or regional differences between respondents, a translation of the verbatim text is preferably provided by a native speaker of each language in which the system is operated.

Alternatively, the system may make use of any of the known processes for automatically translating a phrase in a source language to a target language by; for example, generating a plurality of transduction records and a transduction lattice and merging the transduction records with the transduction lattice as is disclosed in U.S. Pat. No. 6,233,544.

It will be appreciated that a method has been described which provides a quick, easy, and cost effective method of categorizing and coding verbatim responses to surveys. This method also objectively accomplishes such categorizing and coding and is adapted for use in a plurality of languages.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

What is claimed is:

1. A method of analyzing a verbatim text comprising the steps of:
(a) storing the verbatim text in an electronic memory device; and
(b) identifying at least one concept in said verbatim text and linking said concept to a code.

2. The method of claim 1 wherein in step (a) the verbatim text is scanned into the memory device.

3. The method of claim 1 wherein in step (a) the verbatim text is directly entered into the electronic memory device by a person being interviewed during an interview.

4. The method of claim 1 wherein in step (a) the verbatim text is entered into the electronic device by a person other than a person being interviewed after an interview.

5. The method of claim 1 wherein in step (b) said at least one concept is highlighted.

6. The method of claim 1 wherein in step (b) a plurality of concepts are highlighted.

7. A method of analyzing a verbatim text comprising the steps of:
(a) storing the verbatim test in an electronic memory device;
(b) identifying at least one concept in said verbatim text and linking said concept to a code; and
(c) verifying matching of the concept to a code.

8. The method of claim 7 wherein step (a) the verbatim text is scanned into the memory device.

9. The method of claim 7 wherein in step (a) the verbatim text is directly entered into the electronic memory device by a person being interviewed during an interview.

10. The method of claim 7 wherein in step (a) the verbatim text is entered into the electronic device by a person other than a person being interviewed after an interview.

11. The method of claim 7 wherein in step (b) said at least one concept is highlighted.

12. The method of claim 7 wherein in step (b) a plurality of concepts are highlighted.

13. The method of claim 7 wherein matching of the concept to a code is accomplished by viewing a hover text.

14. A method of analyzing a verbatim text comprising the steps of:
(a) storing the verbatim text in an electronic memory device;
(b) identifying at least one concept in said verbatim text and linking said concept to a code;
(c) verifying matching of the concept to a code; and
(d) confirming correct coding by checking the verbatim text.

15. The method of claim 14 wherein in step (a) the verbatim text is scanned into the memory device.

16. The method of claim 14 wherein in step (a) the verbatim text is directly entered into the electronic memory device by a person being interviewed during an interview.

17. The method of claim 14 wherein in step (a) the verbatim text is entered into the electronic device by a person other than a person being interviewed after an interview.

18. The method of claim 14 wherein in step (be) said at least on concept is highlighted.

19. The method of claim 14 wherein in step (b) a plurality of concepts are highlighted.

20. The method of claim 7 wherein matching of the concept to a code is accomplished by viewing a hover text.

21. A method for using a computer network for the purpose of allowing a client to analyze a text, comprising the steps of:
(a) enabling a client to request a site on said computer network and to designate at least one preferred language;
(b) providing a network server and having said network server locate the requested site and pass along the requested language to an in-memory software object that maintains a set of translation strings;
(c) causing the in-memory software object to submit a database query for a list of strings of translations specific to a combination of the client and for the acceptable language;
(d) providing a database server and causing said database server to return at least one of said strings of translations specific to said combination of client and language; and
(e) causing the in-memory software object to locate one of said strings of translations.

22. The method of claim 21 wherein the text is a verbatim text.

23. The method of claim 22 wherein the verbatim text is a survey result.

24. The method of claim 21 wherein the computer network is the world wide web.

25. The method of claim 21 wherein the site is a web page.

26. The method of claim 1 wherein step (a) the client designates a plurality of preferred languages.

27. The method of claim 21 wherein step (b) the network server is a web server.

28. The method of claim 21 wherein in step (b) the network server checks for an established session for the client.

29. The method of claim 21 wherein in step (b) there is no session since the client has made a first request.

30. The method of claim 21 wherein in step (b) the network server asks for credentials from the client.

31. The method of claim 30 wherein the credentials are a username and a password.

32. The method of claim 21 wherein in step (b) the network server creates a session for the client.

33. The method of claim 21 wherein in step (b) the network server passes the credentials to the in-memory software object.

34. The method of claim 21 wherein in step (b) the network server passes the language to the in-memory software object.

35. The method of claim 21 wherein in step (c) the in-memory software object submits a database survey for the language.

36. The method of claim 26 wherein there is a first acceptable language and in step (c) the in-memory software objects submits a database survey for the first language and, if unsuccessful, then submits a database survey for the second language.

37. The method of claim 21 wherein in step (d) each string is identified by a numeric code.

38. The method of claim 37 wherein in step (d) the in-memory software object locates one of the strings by one of the numeric codes.
